(19) United States
(12) Patent Application Publication
(10) Pub. No.: US 2014/0106331 A1
(43) Pub. Date: Apr. 17, 2014

(54) Systems and Methods for On-Line Course Management and Examination Preparation

(71) Applicants: Marc Mitalski, Dawson, IL (US); Kevin Hinders, Champaign, IL (US)

(72) Inventors: Marc Mitalski, Dawson, IL (US); Kevin Hinders, Champaign, IL (US)

(21) Appl. No.: 13/838,655

(22) Filed: Mar. 15, 2013

Related U.S. Application Data
(60) Provisional application No. 61/611,426, filed on Mar. 15, 2012.

(51) Int. Cl. G09B 5/08

(52) U.S. Cl. CPC G09B 5/08
USPC 434/350

(57) ABSTRACT

Systems and methods allow for on-line examination preparation and advertisements relating to the same. Specifically, the systems have four modules: a first module that allows an individual to easily design and present to users a study guide and mock examination system for aiding the users in preparing for an examination; a second module that allows users to easily access the study guide and mock examination system; a third module that allows advertisers to prepare and define advertisements to present to users that utilize the system; and/or a fourth module that analyzes users' performance and/or analyzes advertisers' performance to provide feedback to the individuals who designed the study guide and/or mock examination, the user thereof, the advertiser, and/or any other individual. Each of the modules may be accessible by the various users, whether the individuals that design and present the study guides and mock examinations, the users that utilize the study guides and mock examinations, and/or the advertisers.

The present invention claims priority under 35 U.S.C. 119 to U.S. Provisional Patent Application No. 61/611,426, entitled “Systems and Methods for On-Line Examination Preparation and Advertisements Relating to Same”, filed Mar. 15, 2012, which is incorporated by reference herein in its entirety.

### TECHNICAL FIELD

The present invention relates to systems and methods for on-line examination preparation and advertisements relating to the same. The present invention generally comprises four modules: a first module that allows an individual to easily design and present to users a study guide and mock examination system for aiding the users in preparing for an examination; a second module that allows users to easily access the study guide and mock examination system; a third module that allows advertisers to prepare and define advertisements to present to users that utilize the system; and/or a fourth module that analyzes users' performance and/or analyzes advertisers' performance to provide feedback to the individuals who designed the study guide and/or mock examination, the user thereof, the advertiser, and/or any other individual. Each of the modules may be easily accessible by the various individuals who utilize the systems and methods described herein, whether the individuals that design and present the study guides and mock examinations, the users that utilize the study guides and mock examinations, and/or the advertisers.

### BACKGROUND

It is, of course, generally known that study guides and mock examinations are available to individuals who wish to have assistance as they prepare for an upcoming examination. For example, a student may be interested in preparing for a final examination in a class that he or she is taking for college credit. Alternatively, a professional may be subject to periodic testing to ensure that his or her skills in the profession are current or to ensure that a professional is progressing through certification levels or the like.

Indeed, in a non-limiting example, structural engineers analyze, design, plan, and research structural components and structural systems to achieve design goals and ensure the safety and comfort of users or occupants. Their work takes account mainly of safety, technical, economic and environmental concerns, but they may also consider aesthetic and social factors. In the United States, persons practicing structural engineering must be licensed in the state or states in which they practice. The qualifications for licensure typically include a specified minimum level of practicing experience, as well as the successful completion of a nationally administered exam, and possibly a state-specific exam. For instance, California requires that candidates pass multiple exams, including the National Council of Examiners for Engineers and Surveyors (NCEES) Fundamentals of Engineering Exam (Engineer-in-Training), the NCEES Professional Engineering Exam in Civil Engineering including the California Supplemental Exam which includes a seismic portion and a land surveying portion, and a Structural Engineering Exam.

Moreover, in another non-limiting example, an architect is a person trained in the planning, design and oversight of the construction of buildings. Although there are variations from place to place, most of the world's architects are required to register with the appropriate jurisdiction. To do so, architects are typically required to meet three common requirements: education, experience, and examination. Educational requirements generally consist of a university degree in architecture. The experience requirement for degreed candidates is usually satisfied by a practicum or internship (usually two to three years, depending on jurisdiction). Finally, a Registration Examination or a series of exams is required prior to licensure.

Many other professionals are required to satisfy certain examination requirements to practice their profession, whether an engineer or architect, as noted above, a medical doctor, a lawyer, or other like professional. For example, professional may take examinations to be licensed to practice, or may be required to take continuing education to fulfill requirements and to stay current on changes in the profession. Studying for the professional examinations may be difficult, as many of these professional examinations are not associated with formal classes that one may take, such as in a formal classroom setting in a college or university.

Therefore, examination study sessions or private classes have been created to help fill this void. Moreover, continuing education typically involves a professional taking classes, lectures, or education series relating to the profession. Therefore, a professional desiring to gain extra experience or study may pay an amount of money and take a class with an instructor to aid the professional in obtaining the necessary skills to take and pass the particular examination. However, it is often difficult as a busy professional to have the luxury of time necessary to take an ongoing rigidly structured class on the desired subject. In many cases, busy professionals simply do not have the time to meet regularly at the whim of the instructor and by the instructor's schedule. Many professionals may be busy at work, at home, may be subject to travel restrictions, and the like.

To ameliorate this problem, computer programs have been created that may aid an individual in preparing for an upcoming examination, such as a professional examination. However, typical computer programs may be difficult to utilize, as the information contained within the computer program may be out-of-date, especially if the computer program has been sitting on a shelf. Due to any number of reasons, examinations may change, and the information contained within a computer program study aid may not reflect the actual examination that a user may face, putting the user at a disadvantage.

Moreover, each study guide and mock examination program typically must be created separately from others, such that if one desires to study for an upcoming examination on structural engineering, he or she must purchase the exact computer program that aids in the study of that subject matter. However, typically, if an instructor wishes to have a study aid created for a different subject matter, he or she typically must start anew in the programming of the study guide. Programming a computer application to aid a user in studying for an upcoming examination can be a tedious and inefficient operation.

Another drawback for computer software study guides and mock examination applications is that advertisers may have limitations as to how to advertise within a typical computer program. If a program is an off-the-shelf application, then the possibility of advertisers purchasing advertisement space within the program must be handled and bundled into the software prior to selling the computer program. Even if an application is provided on-line, it may still be difficult for an advertiser to create an advertisement that may be sufficiently current and targeted to a specific user.

For example, if a study guide and mock examination application is designed to aid a structural engineer pass a certification examination, advertisers may be interested in purchasing advertising spots that may be shown on computer screens as the user utilizes the program on his or her computer. In many cases, as noted above, the advertisement must be already present within the computer program well before the user purchases the computer program to aid in his or her study. The advertisement may not be, therefore, current or properly targeted to a user.

Moreover, typical study guides and/or mock or real examinations do not allow for detailed analytical tracking of data points associated with users who may utilize the study guides and/or mock or real examination, without painstakingly entering this information into databases. The analytical tracking of data points is useful for instructors and/or advertisers for tracking particular information about users and/or about subject matter in the study guides and/or mock or real examinations that may be useful for instructors to better their study guides and/or mock or real examinations.

A need therefore, exists for systems and methods that allow for easy creating and presenting of one or more study guides and/or mock examinations by an instructor. Further, a need exists for systems and methods that allow for easy access to study guides and/or mock examinations by a user desiring to study for an upcoming examination. Still further, a need exists for systems and methods that allow for easy access to study guides and/or mock examinations by advertisers that provide the advertisers the ability to present current advertisements that may be targeted to users and/or instructors having access to the systems and methods.

Moreover, a need exists for systems and methods providing access for all three of instructors, students or other users desiring to utilize the same for study, and advertisers, to allow easy accessibility to provide or utilize the information contained therein. A need also exists for systems and methods that provide easy templates for both instructors and advertisers to upload desirable content to present to a user of the same. A need further exists for systems and methods that allow instructor and/or advertisers to change content to provide current information, whether relating to the upcoming examination, or to the advertisement provided by the advertiser.

In addition, a need exists for systems and methods for compiling data points relating to users who may utilize study guides and/or mock examinations that may be useful to instructors and/or advertisers.

### SUMMARY OF THE INVENTION

The present invention relates to systems and methods for on-line examination preparation and advertisements relating to the same. The present invention generally comprises four modules: a first module that allows an individual to easily design and present to users a study guide and mock examination system for aiding the users in preparing for an examination; a second module that allows users to easily access the study guide and mock examination system; a third module that allows advertisers to prepare and define advertisements to present to users that utilize the system; and/or a fourth module that analyzes users' performance and/or analyzes advertisers' performance to provide feedback to the individuals who designed the study guide and/or mock examination, the user thereof, the advertiser, and/or any other individual. Each of the modules may be easily accessible by the various individuals who utilize the systems and methods described herein, whether the individuals that design and present the study guides and mock examinations, the users that utilize the study guides and mock examinations, and/or the advertisers.

To this end, in an embodiment of the present invention, a system is provided. The system, implemented on a computer system, comprises a first module for allowing an instructor to upload instructions relating to an upcoming examination for presentation to a user; a second module for allowing access to the instructions by the user; a third module for allowing an advertiser to upload advertisement content for presentation to the instructor and/or the user, wherein the advertisement is targeted by subject matter to the instructor and/or the user based on the subject matter of the upcoming examination; and a fourth module providing analytical information relating to the user's performance and/or the advertiser's performance.

It is, therefore, an advantage and objective of the present invention to provide systems and methods that allow for easily creating and presenting one or more study guides and/or mock or real examinations by an instructor.

Further, it is an advantage and objective of the present invention to provide systems and methods that allow for easy access to one or more study guides and/or mock or real examinations by one or more users desiring to study for an upcoming examination.

Still further, it is an advantage and an objective of the present invention to provide systems and methods that allow for easy access to study guides and/or mock or real examinations by one or more advertisers that provide the advertisers the ability to present advertisements targeted to users and/or instructors having access to the systems and methods.

Moreover, it is an advantage and objective of the present invention to provide systems and methods providing access for all three of instructors, students or other users desiring to utilize the same for study, and advertisers, to allow easy accessibility to provide or utilize the information contained therein.

It is further an advantage and objective of the present invention to provide systems and methods that provide easy templates for both instructors and advertisers to upload desirable content to present to a user of the same.

Moreover, it is an advantage and objective of the present invention to provide systems and methods that allow instructor and/or advertisers to change content to provide current information, whether relating to the upcoming examination, or to the advertisement provided by the advertiser.

Still further, it is an advantages and objective of the present invention to provide systems and methods for compiling data points relating to users who may utilize study guides and/or mock or real examinations that may be useful to instructors and/or advertisers.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a system of the present invention showing four modules: an instructor module; an advertiser module; a user module; and an analytics module.

FIG. 2 illustrates a screenshot showing an instructor interface allowing an instructor to create a study guide and/or mock examination in an embodiment of the present invention.

FIGS. 3-4 illustrate screenshots showing an advertiser interface allowing an advertiser to create and/or upload targeted advertisements to users in an embodiment of the present invention.

FIGS. 5-10 illustrates screenshots showing a user interface allowing a user to select and perform a study guide and/or mock examination of a topic or subtopic, in an embodiment of the present invention.

### DETAILED DESCRIPTION OF THE PRESENTLY PREFERRED EMBODIMENTS

The present invention relates to systems and methods for on-line examination preparation and advertisements relating to the same. The present invention generally comprises four modules: a first module that allows an individual to easily design and present to users a study guide and/or mock or real examination system for aiding the users in preparing for an examination; a second module that allows users to easily access the study guide and mock or real examination system; a third module that allows advertisers to prepare and define advertisements to present to users that utilize the system; and/or a fourth module that analyzes users' performance and/or analyzes advertisers' performance to provide feedback to the individuals who designed the study guide and/or mock or real examination, the user thereof, the advertiser, and/or any other individual. Each of the modules may be easily accessible by the various individuals who utilize the systems and methods described herein, whether the individuals that design and present the study guides and mock examinations, the users that utilize the study guides and mock or real examinations, and/or the advertisers.

The modules of the present invention may be contained within a single computer program, or may be constructed as one or more separate programs or modules that are linked together to form the entirety of the present invention, as is apparent to one of ordinary skill in the art. In a preferred embodiment, the modules of the present invention may be contained and accessible on the Cloud to provide a plurality of users to gain access simultaneously. It should be noted that the modules, as detailed herein, may be programmed using any computer software programming language, and may be implemented on a computer system, whether as a stand-along system, or a networked system, such as, for example, on an internet-based system, as apparent to one of ordinary skill in the art. Preferably, the systems and methods of the present invention described herein are accessible by an instructor, a user, an advertiser, an administrator, or any other individual, through the internet.

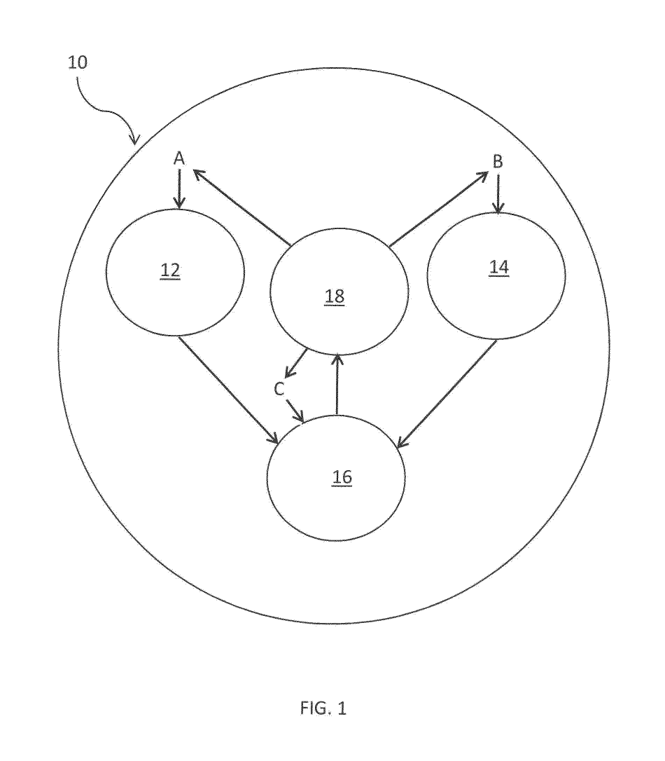

Referring to FIG. 1, a representation of system 10 of the present invention is provided. Specifically system 10 incorporates four modules: a first “instructor” module 12, a second “advertiser” module 14, a third “user” module 16, and a fourth “analytics” module 18.

One or more instructors, represented by “A” on FIG. 1, may utilize the instructor module 12 to prepare study guides, self-guided and/or live educational courses, and/or mock or real examinations, as described in further detail below, and enter the same, whether by direct entry thereof or via uploading information thereof, to the instructor module 12. Therefore, the instructor module 12 may create one or more study guides and/or mock examinations based on the information provided by the instructor A using the entry templates provided to the instructor A via the instructor module 12. A plurality of instructors or other users may gain access to the present invention for review and editing of the same, either one at a time or simultaneously.

In addition, an advertiser, represented by “B” on FIG. 1, may wish to enter and/or upload information concerning an advertisement that the advertiser B may wish to be viewed by a user (“C”) of the system 10. The advertiser B may create a targeted advertisement relating to the advertiser, including relevant information and functionality, such as links and the like, via the advertiser module 14, which may present a template for entry of the advertisement information to the advertiser B. The study guides and/or mock examinations, entered or otherwise uploaded by the instructor A, and the advertisements entered or otherwise uploaded by advertiser B, may be utilized to create a combined presentation that may be presented to the user C, when the user C utilizes user module 16 for utilization of the study guides and/or mock examinations.

After the user C utilizes user module 16 as a study guide, a self-guided or live educational course, and/or for a mock examination, the analytics module 18 may evaluate the user's performance and provide analytical feedback to the user C to aid the user C, such as information relating to the types of questions answered correctly or incorrectly, statistical analysis of the answers given, and other information. Moreover, the analytics module 18 may provide analytical analysis to the instructor A, such as information to help the instructor create a better or different study guide and/or mock examination. In addition, the analytics module 18 may provide analytical analysis and related information to the advertiser B to help the advertiser B evaluate the effectiveness of the advertisement and/or for any other purpose apparent to one of ordinary skill in the art.

### Instructor Module

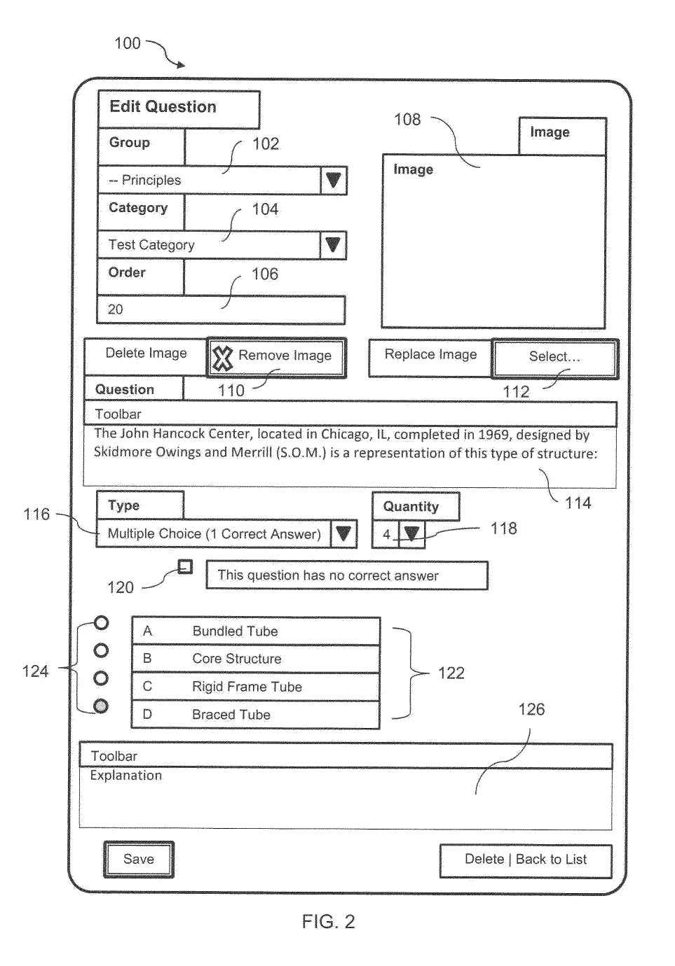

Referring to FIG. 2 and subsequent figures, exemplary and representative screenshots are illustrated showing how an instructor may enter information relating to the study guides, educational courses, and/or mock or real examinations that may be utilized by the user C. Specifically, the instructor or preparer of the study guides, educational courses and/or mock or real examinations may be provided with easy templates to enter information concerning the question type (whether multiple choice with a single answer, multiple choice with multiple answers, essay style, fill-in-the-blank, true-false, or other like question types). It should be noted that throughout the present invention, use of the term “instructor” signifies a user who enters information relating to the study guides, educational courses, and/or mock or real examinations, but it should be apparent that others may also prepare the material entered therein, and use of the term instructor is not meant to be limiting.

The instructor may then be provided a field for entering text, graphics, insertion of hyperlinks or the like detailing the question. Moreover, the instructor may then be afforded the opportunity to enter or upload information, such as text, audio, video, insertion of hyperlinks or the like, relating to an explanation of the correct answer, that may be displayed to a user upon answering the question, such as if the user chooses to have the explanatory information provided based on his or her answer. The instructor may then have the ability to save the question and related information entered and/or uploaded.

In another embodiment of the present invention, the instructor may utilize the system to provide a lecture series instead of a study guide or a mock exam, or in conjunction with a study guide or mock exam, as detailed below. Specifically, the lecture series may be provided to the end user thereof as a self-guided course or series, or in a live application. Specifically, if utilized as a self-guided course or study guide, information relating to the materials may be stored by the system of the present invention and accessed by an end user thereof. If utilized as a venue for presenting a live presentation, then the present invention may allow an end user to have access to the system at the same time an instructor provides the live demonstration, which may be uploaded in real time to the system for access by the end user.

The systems and methods of the present invention may have enhanced security features to ensure and/or minimize cheating by end users or use by end users on the same account. For example, the systems and methods of the present invention may validate that one user is not entering the system by more than one IP address simultaneously. Moreover, the systems and methods of the present invention may flag users that may originate from a relatively high number of IP addresses non-simultaneously. Thus, usage by a plurality of users on a single account may be detected.

It should also be noted that the present invention may be easily integrated with other known education/technology software and/or hardware, such as Mimio Smartboard, Mimio Table, Papershow, Livescribe, or other like software and/or hardware.

In an exemplary embodiment of the present invention, FIG. 2 illustrates a screenshot 100 for an instructor to create and/or edit questions that may be presented to users. Specifically, the screenshot 100 may include a “Group” field 102 that may allow an instructor to specify the type or kind of question that the instructor wishes to ask, such as via a drop-down menu, or via any other method. In the example shown in FIG. 2, the group specified is “Principles”, but the group may be any type or kind apparent to one of ordinary skill in the art. Indeed, the choices presented to an instructor in the Group field 102 may be dictated by the instructor for his or her own grouping of questions as he or she develops the study guide and/or mock examination, as provided herein.

Next, a “Category” field 104 may allow the instructor to designate which category the question may belong, and whether the question may include a “subcategory”. An “Order” field 106 may be provided so that the instructor can tailor the number that the question may be when presented in a particular order. It should be noted, however, that the present invention may also provide the ability for the user to randomize questions, in which case the order provided by the instructor will not apply. Moreover, the present invention may also provide an instructor an ability to hold questions back from a study guide so that they may be used on a mock exam, so that the user is not getting identical questions on both the study guide and the mock exam.

Next, an image may be uploaded to “Image” field 108 so that an image may be displayed to the user that may be using the question in a study guide or a mock examination. In the example provided in Screenshot 100, the image is a photograph of the John Hancock Center in Chicago, Ill., and the question presented, as noted below, therefore, relates to the John Hancock Center.

A “Remove Image” button 110 may be provided that may allow an instructor to remove the image from the Image field 108, such as when an instructor accidentally uploads an incorrect image, or if the instructor determines that a better image may be provided, or no image at all. A “Replace Image” button 112, thus, may allow the instructor to directly change the image, as desired.

A “Stem” field 114 may allow the instructor to enter information concerning the particular topic or question that may be presented to a user. As noted above, and in more detail below, the Instructor Module may be utilized to create a lecture series, whereby the stem of a topic or discussion may be presented to a user, and a lecture may be presented to provide instruction to the user regarding the topic or discussion. Preferably, however, the instructor may create the study guide and/or mock exam, as detailed herein, and the stem field 114 may allow the instructor to enter the information pertaining to the particular question. Therefore the term “stem” refers to a topic that may be the subject of a question presented in a study guide and/or mock exam, or may be a relevant topic that may be presented in a lecture format. For purposes of the present invention, it should be noted that the term “stem”, “question”, “content” or “topic”, as used throughout the application, may apply to a variety of topics utilized for study guide purposes, mock exam purposes, and lecture or discussion purposes.

Stems may be provided with certain defining properties, including information about the author thereof, an assigned difficulty rating (which may be automatically generated by the system of the present invention based on collected metrics), an assigned order for content searching, which may be turned off for randomization of questions, a draft or published status which may allow an instructor to specify when the stem is ready to be viewed by an end user, and other like defining properties.

Other features may be provided to the instructor when designing course material, study guides, mock or real examinations or the like, such as equation editors that may aid an instructor in designing a question requiring simple or complex mathematical equations. Moreover, the systems of the present invention may allow instructors to designate sample equations that may be utilized to generate questions using different numbers from one end user to another, or for an end user at different times. More specifically, variables in mathematical equations may be dynamic such that, while an equation may be presented in a question or study guide, the variables may specifically change so that the user is not presented with identical questions each time, or that different users are not presented with identical variables.

The instructor may change the text as generally shown in field 114, such as whether bold, italics, the font, the font size, and other formatting matters. Other information, such as information contained with media files, such as photographs, images, icons or the like, or multimedia files, may be provided in the Question field 114, such as audio or video files, or the like.

A “Type” field 116 may allow an instructor to select the type of question, such as whether multiple choice with a single correct answer, multiple choice with multiple correct answers, true/false, fill in the blank, essay, or other. The type of question may dictate the information required to be entered by the instructor to complete the question. For example, if a multiple choice with a single answer question is selected, as shown in Screenshot 100, the instructor may be presented with a choice to dictate the quantity of choices in the “Quantity” field 118 (showing “4” selected in Screenshot 100). Field 120 may allow an instructor to specify that there is no correct answer, allowing an instructor the ability to teach how to identify a question that may not have a correct answer to aid a user in studying for the upcoming examination.

Field 122 presents to the instructor the ability to enter text relating to the specific choices that may be presented to the user, such as via choices A, B C, and D. Field 124 allows the instructor to specify the correct answer, such as “D” in the example shown in Screenshot 100.

Finally, there may be an “Explanation” field 126 provided to the user for the instructor to present details information concerning the correct answer that may be utilized by the user to help study for an upcoming examination. As with the Question field 114, above, the text may be formatted in any manner. Moreover, photographs, images, icons, video files, audio files, and other like media, may be added to the Explanation field 126 to offer the user the detailed explanation by the instructor to determine the correct answer, and buttons may be presented to the instructor to add the same.

The information provided by the instructor using the Instructor Module, and represented by Screenshot 100, may be saved, and incorporated into the User Module, as provided in detail below. In addition, the instructor may have the ability to easily copy and/or replicate a particular stem, whether question, topic of discussion or otherwise. This may be useful if an instructor wishes to replicate most of the content, without having to start over with the creation thereof. For example, an instructor may wish to have similar questions, but worded slightly differently, to aid a user in studying. Therefore, a user may be required to pay more particular attention to the wording to ensure understanding thereof. Alternatively, an instructor may simply wish to replicate a particular style of question by copying an already created question, and changing the topic, the wording of the question, the answers, the images, the videos, the graphics or the like.

In an alternative embodiment of the present invention, a lecture series study guide may be presented to a user of the present invention to aid a user in learning about a particular subject. For example, the Screenshot 100 may easily be utilized to provide to a user information concerning a lecture, such as an audio file or a video file, of the instructor lecturing. For example, the Question field 114 may allow an instructor to upload any multimedia files, such as a video file of a daily lecture. Further information may be provided, such as the topic of the lecture, and other like information, that may help a user focus on the particular lectures, or to aid in helping a user pick up where he or she left off.

Questions relating to the lecture, such as review questions, or the like, may be associated with the lecture video file to aid a user in testing him or herself after listening to and/or watching the lecture

Of course, the present invention provides the ability to create study guides, mock examinations, lectures, or combinations of any or all of these, to aid a user in learning a subject and/or preparing for an upcoming examination.

Once information about particular questions, for a mock or real examination, and/or for a course study guide or lecture series, is entered into and stored by the system of the present invention, the instructor may utilize certain functionality to specifically tailor course schedules, topics, question distribution, and other like functionality, based on how the instructor wishes the course and/or mock or real examination may be presented to an end user. For example, if an instructor designs an examination cover a plurality of sub-categories, the instructor may set the examination to pull questions from a pool of each subcategory to fill the examination, which may be different for each user, and different for a user that accesses the system at different times.

Moreover, the instructor may add further information concerning each question, topic or stem relating to a time duration. For example, if in an examination session, the instructor may designate the total time for the examination, or may have the system determine the number of questions to populate an examination based on the time duration set by the instructor.

Content groups relating to categories and/or subcategories of topics, questions, stems or other like content may be defined in various ways, such that the information may be presented to an end-user based on properties of the end-user and the defined content. For example, certain content may be defined for certain professionals, and when an end user identifies him or herself as one of the professionals, the certain topics may then be accessible to the user.

The instructor may further have the ability to choose from among many templates for presentation of the information entered into and stored by the systems of the present invention. For example, an instructor may select full screen presentation, split screen presentation or any other presentation allowable or designated as selectable by the systems of the present invention.

It should also be noted that the content designed by the instructor in the systems and methods of the present invention may be combined to present alternative presentations to end users, such as combinations of lecture series and examination questions. For example, in a self-guided course lecture series, the content may be defined such that after a certain period of time of lecture, mock or real examination questions may be presented to the end user.

The instructor may further have the ability to add reference material that may be accessible to an end user when utilizing the course material. For example, an instructor may provide a reference book that may be presented in pdf format for a user to utilize during the course, study guide or examination. Optionally, the instructor may charge end users for use of reference materials, or may provide the reference materials to the end user as part of the course without fee.

Preferably, the present invention allows one or a plurality of instructors or other users to have simultaneous access to the stems created herein, so that the stems may be edited, changed, reviewed or otherwise manipulated by a plurality of reviewers simultaneously without having to share files or track current versions.

### Advertiser Module

In a separate module of the present invention, as represented by advertiser module 14 in FIG. 1 an advertiser may have the ability to provide and upload targeted advertising to users of the systems and methods as described herein. Specifically, an “advertiser module” may be a separate aspect of the present invention, wherein the advertiser or an administrator, may provide specific advertising information that may be presented to users as users utilize the systems and methods of the present invention.

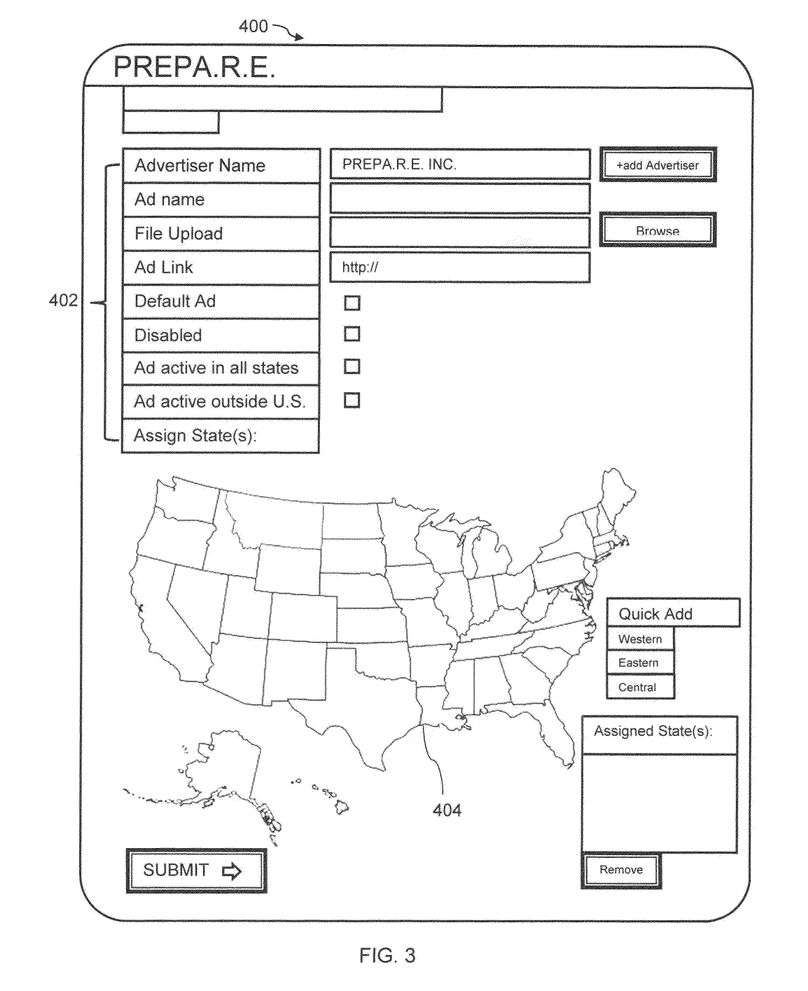

Referring now to FIG. 3, an exemplary screenshot 400 of the present invention is illustrated. The screenshot 400 provides an advertiser and/or an administrator the ability to upload advertisements and related information to the systems and methods, as described herein. Specifically, the advertiser may be presented with a plurality of queries 402 relating to the information about the advertisement, including the Advertiser Name (or a link to add an advertiser name and related information), the Ad Name, the File Upload file name (and related “browse” button), an Ad Link to associate with the advertisement that is uploaded, and options relating to whether the ad is a Default Ad, whether it should be disabled (i.e., not provided to users), whether the ad should be active in all states, and/or whether the ad should be active outside the United States. Moreover, specific states may be selected, or specific regions may be selected, as described in further detail below.

For example, an advertiser, administrator, or otherwise those with access to the advertising module such as, but not limited to, sales personnel, a media company, or the like, may select the advertiser's company name in the “Advertiser Name” field, and provide an “Ad Name” for the particular advertisement. The advertisement, which may consist of an image having information thereon, may be uploaded via the “File Upload” field. A URL may be provided in the “Ad Link” field to be associated with the uploaded advertisement image. The URL may then be associated with the advertisement image, such that when the advertisement image is presented to a user of the present invention, the user may click on the advertisement image, and the user may be sent via his or her web browser to the link associated with the advertisement image, such as, for example, to the advertiser's website. Finally, an “Ad Caption” field (not shown) may be included, which may allow an advertiser, administrator or the like, to add a text statement that may be associated with the advertiser's name or logo and may be a specific statement that may be tied to the advertiser and communicated when the advertiser's name or logo is utilized and presented to a user. The “Ad Caption” field may allow advertisers or other administrators to provide positive reinforcement of the advertiser's name or logo, further integration and connection of the content of the system with the advertiser, and a co-branding opportunity between the advertiser and the instructor or content provider.

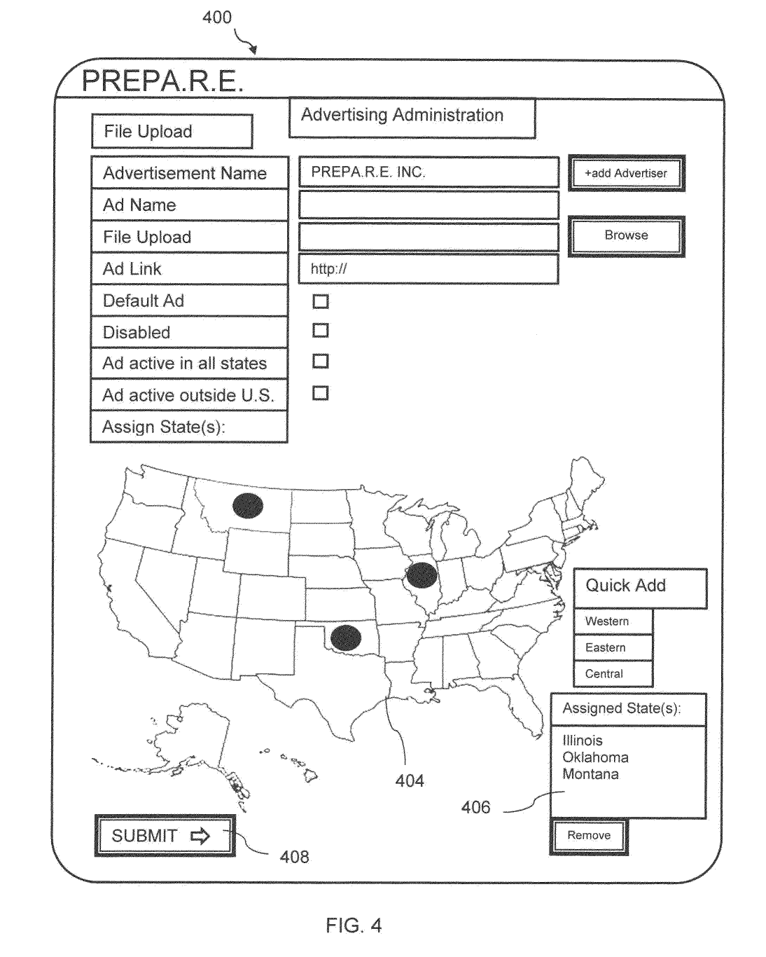

The map of the United States 404 may provide an easy and efficient manner for an advertiser or administrator thereof to select the specific states for the advertisement to be displayed. Therefore, the systems and methods of the present invention utilize the location information of the user (which is typically provided by the user as a condition for sign-up to the system) to target specific advertisements to the user. For example, as illustrated in FIG. 4, if an advertiser selects “Illinois,” “Oklahoma” and “Montana,” then the uploaded advertisement will only be presented to users who list one of those three States as their places of residence. The selected states may be provided in field 406, and may be blanked out on the map 404.

Once the advertiser or administrator is satisfied that the information provided is sufficient, the advertiser or administrator may select the “SUBMIT” button 408 (or other aptly named button, such as “OK”) to submit the advertisement for review and placement within the study guide and mock examination systems and methods of the present invention.

Advertisements may be associated with a particular geographical region, as described above, such as state-by-state, by region, or to other countries, for example. The advertisements may also be assigned to particular questions within one or more study guides and/or mock examinations. Thus, advertisements may be associated with particular questions or stems because the good/service advertised may directly relate to the question or stem, and the advertisement may inform the user of more in-depth information about the topic at hand and where to obtain a possible solution to the problem, for example.

Advertisers may be set as default advertisements that may appear to users regardless of geographic specificity. The systems and methods of the present invention may utilize a priority ranking for the advertisements in the case of two or more advertisements being available for a particular question.

Advertisers may also receive analytical information relating to the advertisements that may be entered and/or uploaded, which is further detailed below in the “Analytics Module”. Advertisers or other administrators may, for example, receive specifically-tailored analytics relating to one or more advertisements that includes information about when or how often an advertisement appeared on a user's computer screen, how long the advertisement stayed on the computer screen, whether the user utilized any ancillary functionality associated with the advertisement, such as whether the user clicked on an embedded and/or associated link thereof, and other like information. Therefore, an advertiser may obtain up-to-date information concerning the effectiveness of the advertisement.

Advertisements added to the systems of the present invention may be associated with particular individuals, such as sales people, and the like for tracking purposes. Therefore, for example, contacts may be tracked for particular advertisements that may be useful for assigning royalties for sales, or for clicks on the advertisements, or for any other reason.

### User Module

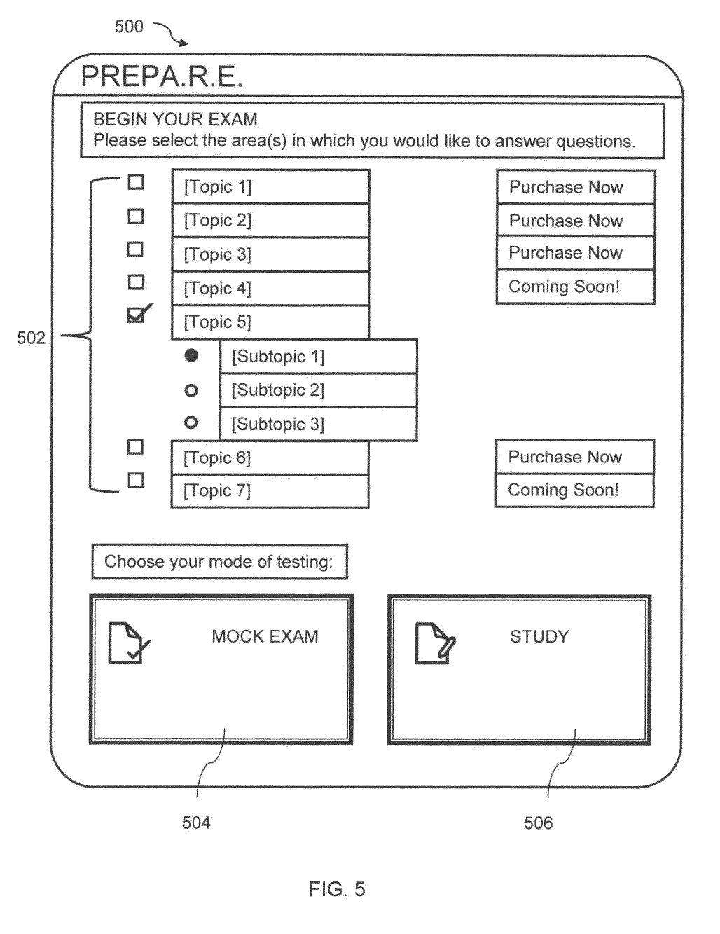

Referring to FIG. 5, a screenshot 500 is presented. The screenshot 500 represents a main menu for a user of the systems and methods described herein, and may be part of a user module 16 that allows a user of the systems and methods described herein to aid the user in studying for an upcoming examination. Specifically, the systems and methods of the present invention may present a plurality of subject areas for selection by the user, depending on which subjects the user wishes to study.

Specifically, the screenshot 500 includes a plurality of selections 502 that may be presented to a user for the user to select the topic of the examination preparation. In the example shown in FIG. 5, the topic selected is generally denoted generically as “[Topic 5]”, which may be, for example, “Structural Systems” from an architecture examination. Within that topic, the specific subtopic, generically denoted as “[Subtopic 1]”, may be “Principles” that may be an important subtopic of the topic “Structural Systems” of the architecture examination. Of course, a user of the system may select any of the selections provided. Each selection may be subject to a fee, which the user may pay when selected. A “purchase now” link may be provided associated with each selection 502 to allow the user to select and pay for each selection, as desired.

Beneath the plurality of selection 502 may be a link to a “Mock Exam” 504 and a link to a “Study” guide 506. The user may select whether he or she wishes to participate in a mock examination by selecting the “Mock Exam” 504 link, which will provide a series of questions to the user that simulates an actual examination. Specifically, if the user wishes to take, as shown in the figures, the “Architect Registration Examination” (“A.R.E.”), and if the user further selects the “Mock Exam” 504 link, then an examination will be presented to the user that simulates, as closely as possible, the conditions of a real A.R.E.

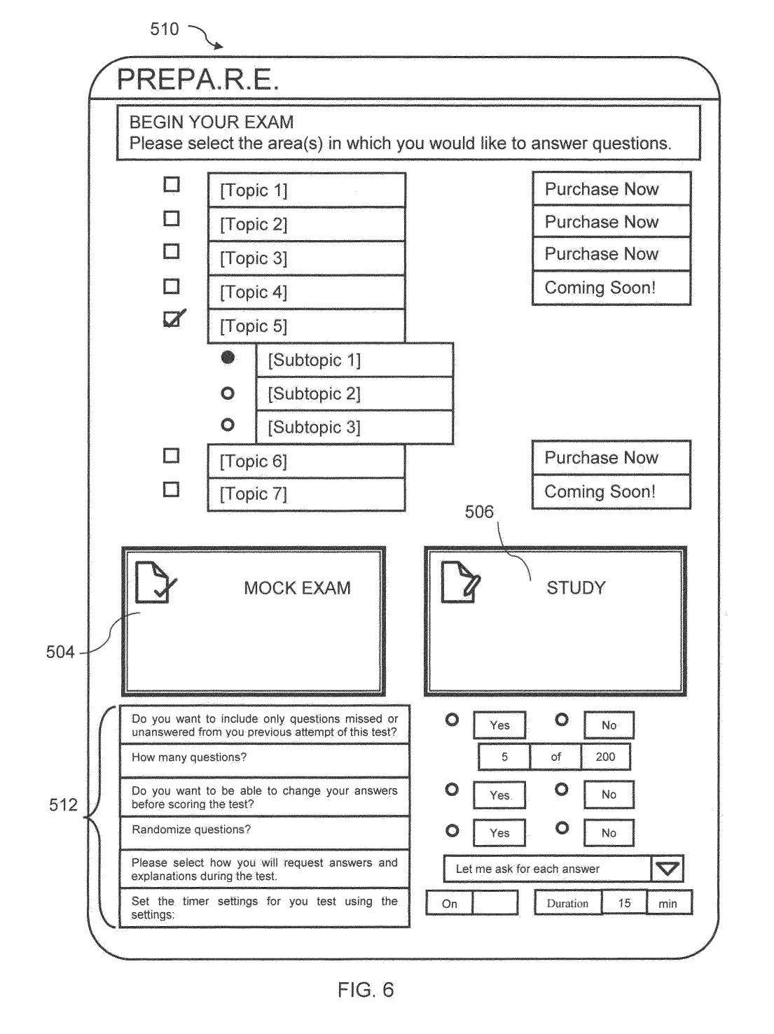

Alternatively, if the user selects the “Study” guide 506 link, then a plurality of examination questions may be presented to the user, whereupon the user has increased control over the information presented, checking answers, looking up answers, and the like, as described below with reference to FIGS. 6-10.

Referring to FIG. 6, a screenshot 510 is illustrated, which may be presented to a user after the user selects the “Study” guide link 506. Specifically, the screenshot 510 may present the user with a series of questions 512 that allow the user to determine how much to study and under what conditions. As provided, the user may select that he or she wishes to see only questions that were missed or unanswered from previous attempts at the test. This allows a user to hone in on problem areas and/or questions that may pose particular problems for the user. In addition, the user may select how many questions to review. Another option presented to users may be to allow the user the ability to change his or her answers prior to scoring the test. The user may also select whether to randomize the questions. A user may select whether the guide automatically provides explanations to answers, or only upon request by the user. In addition, the user may select to turn timer settings on and for how long. Of course, other choices may be presented to a user as apparent to one of ordinary skill in the art. The functionality provided allows a user to tailor the conditions for studying for the test, without necessarily having the full panoply of testing conditions that may be presented to a user if the user selected the “Mock Exam” 504 link.

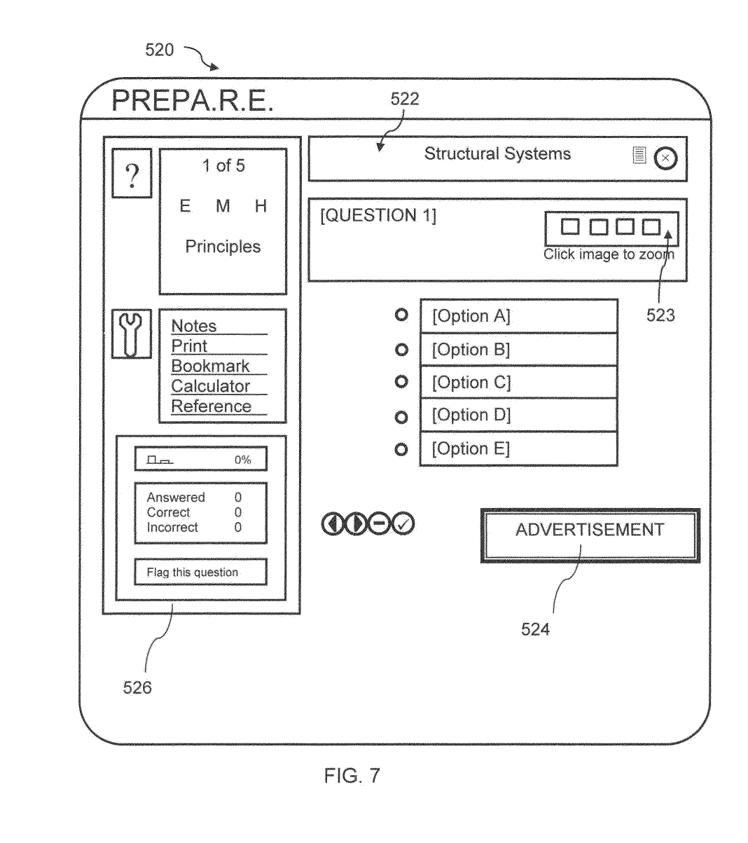

Once the user provides his or her parameters for study, the systems and methods of the present invention present to the user a sample examination question. The sample examination question may be a question that the user may see on the upcoming examination, and may be designed to test the user on a particular aspect of the topic or subtopic of the upcoming examination. Specifically, a sample question 522 is illustrated in screenshot 520, as shown in FIG. 7. The sample question 522 may present a question with a plurality of answers, represented by choices (a)-(e). In addition, a plurality of figures or images 524 may be shown that may be utilized with the question. In this example, several structural examples are provided as choices (a)-(e). The user may select what he or she considers the correct answer by selecting the circle next to answer. At that time, the user may simply move on to the next question by hitting the right arrow beneath the question, clear the answer for selecting a different answer by hitting the dash (“-”), or check the answer by selecting the check mark. By selecting the check mark, a detailed explanation may be provided to the user explaining whether the user selected the correct answer and providing pertinent information on the correct answer.

An advertisement graphic 524 may be presented, as shown on screenshot 520, that may provide an advertisement to the user. For example, a company may wish to advertise to users as the users study for the upcoming examination. The advertisement may be targeted to the users, especially based on the subject matter of the upcoming examination as well as their geographic location, or some other characteristic or characteristics of the user. For example, if the user is studying for the A.R.E., advertisers may wish to advertise goods and/or services relating to architects. The advertisement may have associated links or other functionality, such as an external link, to take the user to the advertiser's website, for example. The systems and methods of the present invention allow advertisers, administrators, sales personnel, media companies, and other like individuals or entities with a great degree of freedom and ease to upload tailored advertisements, the detail of which is described above with reference to the “Advertiser Module.”

On the left side of screenshot 520, information relating to the study guide and questions presented therein may be provided in field 526. For example, the number of the question and the total number of question in the study sample selected by the user may be shown. Information concerning the degree of difficulty for the particular question 522 may be provided, whether easy “E”, medium “M” or hard “H”. Information concerning the amount of questions answered, whether correct or incorrect, and a percentage of correct answers may further be provided. However, the user may opt to disable information concerning the questions and whether correct or incorrect, and/or the percentage of correct answers if the user is taking a mock exam versus studying the study guide or reviewing lecture series to better simulate actual test conditions. Moreover, the user may be provided with the ability to toggle to the user scoring summary screenshot 550, as detailed below.

In addition, the field 526 may provide tools to users as the users proceed with the study guide. For example, if a user wishes to take notes relating to the question, the user may select a “NOTES” link, which may provide a pop-up box or other field for the user to jot down notes and save the same by associating the note with the question for further review. The user may select a “PRINT” link (if provided), to print the question or the detailed explanation thereof. The user may wish to select a “BOOKMARK” link that will allow the user to go back to that question after the study guide is complete to review the same. Specifically, if a question is “bookmarked”, the content slide for that question may preferably appear in the user summary screenshot 550 to inform the user that they indicated that they wanted to evaluate the content further. A link to a “CALCULATOR” may be provided if the user must perform math. And finally, a “REFERENCE” link may be provided, that may allow the user to gain additional information concerning the particular question, such as an external link that may send the user to another webpage for further information. Of course, other information or links may be provided to the user in the field 526 to aid the user in studying the particular subject matter.

Field 523 presents to a user images that may be presented to the user as the user attempts to answer a questions, such as in a study guide, mock exam or lecture series. Each of the images may be associated with an option for answering, and may be zoomed for better viewing thereof.

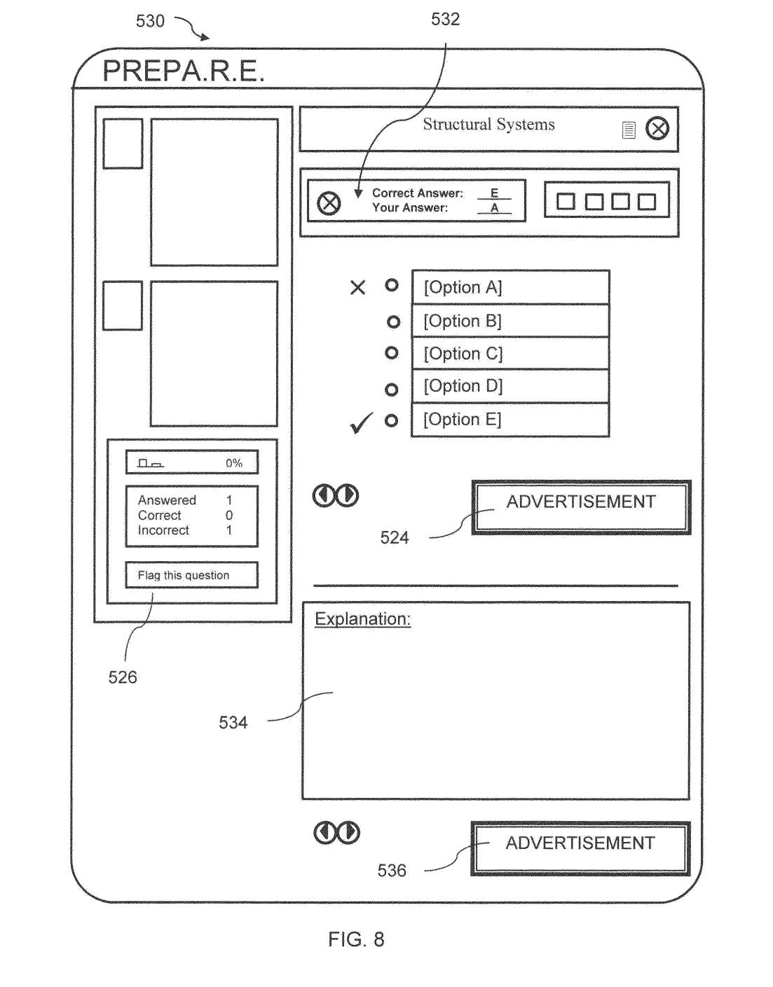

If a user wishes for further detailed information concerning whether the user selected the correct information, the user may select the check mark on FIG. 7, which may present the detailed information, as represented by screenshot 530 of FIG. 8. Specifically, screenshot 530 may inform the user whether the user correctly selected the answer, as shown in field 532. Moreover, an “Explanation” field 534 may be presented to the user offering the information helpful to the user in selecting the correct information. The field 526 may further be updated automatically showing the number of questions answered and whether correct or incorrect. An additional advertisement 536 may be presented to the user, as shown in screenshot 530. The user may select whether to move to the next question, or whether to go back to an earlier question using the arrows.

The Explanation field 534 may contain, simply, text, graphics, images, and/or the like for communicating to the user the explanation of the answer to the question presented. In addition, or alternatively, a video may be displayed, either as a pop-up window, or an embedded window, to provide the explanation from the instructor or other like individual. Any other information may be provided to the user as may be useful for imparting the information relating to the explanation of the answer to the question presented.

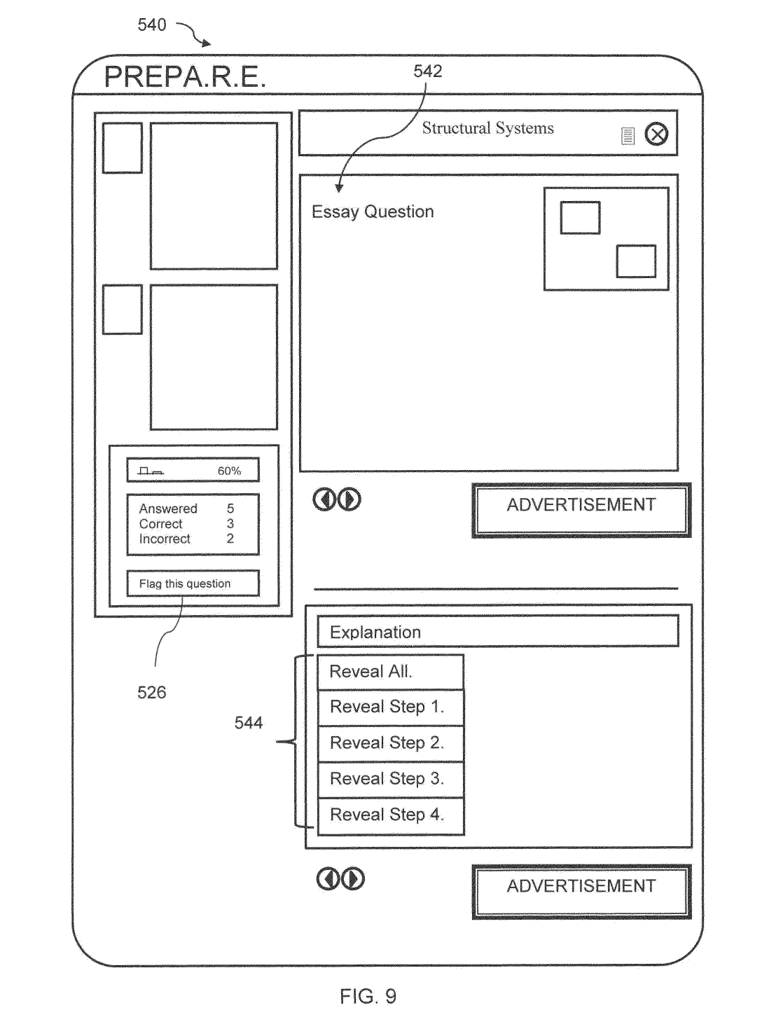

FIG. 9 illustrates exemplary screenshot 540, which shows another sample questions that a user may face on an upcoming examination. The question 542 may be an essay question, and may request that the user write out how he or she obtained the answer desired. When the check mark is selected, the user may be presented with explanation links 544 that may allow the user the ability to open explanations of all steps or only some steps. This may be useful if a user wishes to obtain information on one of the steps but not all of the steps. Essay style questions may be self-scoring. For example, scoring guidelines and points earned or points deducted may be provided by the instructor in the explanation. The user may then compare their solution to the steps and award their own points, providing detailed information on whether the user has sufficiently explained the topic to warrant a pass or fail evaluation for that questions. If the user earns enough points to pass, they may select the “correct” option. If the user does not earn enough points to pass, they may select the “incorrect” option. Thus, scoring for the entirety of the exam may be implemented pursuant to the systems and methods provided herein, even for essay style questions. The field 526 may further be updated to show the number of questions answered, whether correct or incorrect, and the percentage of correct answers at that point in the study guide.

Moreover, screenshot 540 may also illustrate how a lecture series may be presented by an instructor using the systems and methodology of the present invention. Specifically, the “Essay Question” field 542 may present text, graphics, or other media, such as, for example, preferably videos, to present to a user a stem of a particular topic or discussion. The user may also have explanation links 544, as described, that allow a user to reveal portions of the topic as needed or necessary during the lecture.

It should be noted that any number of topics, whether in the form of a discussion “stem” or a question, may be provided within the study guide for a user to review, as may be apparent to one of ordinary skill in the art. Moreover, a plurality of types of questions may be answered, such as multiple choice with a single correct answer, multiple choice with the possibility of multiple correct answers, fill in the blank, true/false, essay questions and the like.

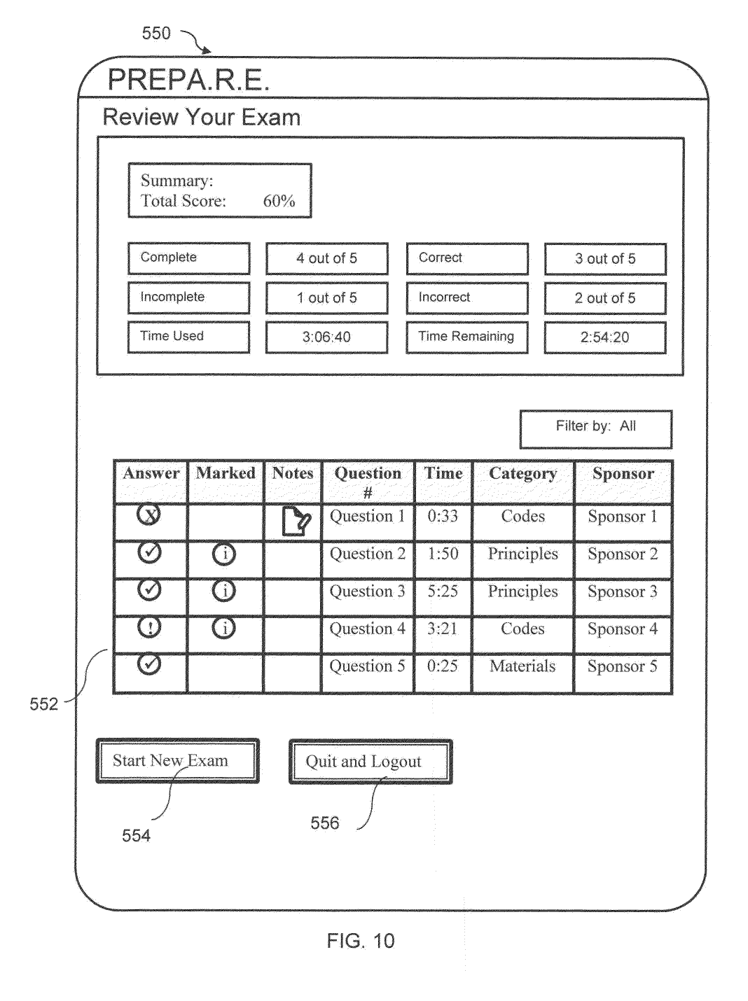

Screenshot 550 is illustrated in FIG. 10, which shows a user a review of his or her examination, and may provide simple analytical information about the user's performance. More detailed and specific analytical information may be generated and provided to the user, as detailed below in the “Analytics Module.” The screenshot 550 may show any pertinent information, such as, for example, the total score by percentage, the number of complete answers, incomplete answers, correct answers, incorrect answers, the time used and time remaining (if a timer setting is activated), and pertinent information on each questions. As shown in FIG. 10 in an exemplary embodiment of the present invention, five questions were reviewed by the user, and information may be presented to the user as shown in the chart 552. For example, information concerning whether the question was answered, whether it was bookmarked by the user, whether the user took notes on the question, the time it took to evaluate, review and/or provide an answer to the content, the category of the question, and any advertiser associations for the questions. The questions may be linked so that a user may select the question to see the full question in the chart. Of course, any other information may be presented to the user as apparent to one of ordinary skill in the art.

In addition or alternatively, the present invention may store historical information relating to all of the user's attempts to answer questions, including percentages of questions answered correctly, and detailed analytical information concerning the historical data, as detailed below.

The user may then select to start a new exam or whether to quit and logout. If the user wishes to start a new exam, the user may select the “START NEW EXAM” link 554, which may bring the user back to the starting menu, for example. Alternatively, the user may wish to select the “QUIT AND LOGOUT” link 556 to quit the program.

As discussed above, instructors may add time limits to their examinations, whether in mock examination mode or in real examination mode. Users may adjust settings at the instructors' discretion, such as during a mock examination if the user must pause the test, he or she may select to pause the timer. These options may be usable by a user during mock examination, but may not be usable by a user during a real examination presented by the present invention.

It should be noted that the user of the present invention may also be provided with the ability to upload his or her own reference material that may be utilized at will by the user, if allowed by the instructor. The reference material uploadable and accessible by the user may also be provided to other users, at the discretion of the instructor, as apparent to one of ordinary skill in the art. Thus, a user may make a particular uploaded reference accessible to others that may also be enrolled in the course, study guide, or examination.

Moreover, the user may also be presented with the ability to offer feedback to the instructor that may allow the instructor to understand better how a user may receive the materials, whether questions may be poorly worded or whether lectures may be particularly difficult to understand. Thus, the user may provide direct feedback and communication to the instructor that may aid the instructor in designing the course and/or examination. Because the systems of the present invention preferably allow multiple users to access the system, feedback may be reviewed by one or more instructors simultaneously, and responses and updates to particular questions or stems may be pushed to all users of the system immediately.

### Analytics Module

The present invention allows for the detailed tracking of information relating to the users and their test-taking abilities based on questions answered when reviewing the study guides and/or mock examinations, as well as advertisements associated with questions, as noted above. While the particular information relating to a study guide and/or mock examination may be provided to a user, instructors may also utilize the analytical information to help tailor questions or explanations to aid users in their study and preparation for upcoming examinations.

Specifically, data may be generated relating to questions and user answers, as well as information concerning the users. For example and without limitation, data relating to the exam category, the exam itself, the date range of study by the user, any particular university or school, the user's location, such as region or state, the author/instructor of the questions, the difficulty of the question, and the advertiser, may be prone to filtering and analysis.

Data points that may be tracked include, without limitation, the following:
Total number of questions and answers
Total number of subscribers (users)
Total number of views
Total time viewed
Average time per view (total views/total time)
Average number of sessions per day
Average number of problems viewed per day
Average length of session per day
Total number of referrals to sponsored links
Average number of referrals to sponsored links per day
% correct first attempt per subscriber (user)
% correct all attempts per subscriber (user)
Problem(s) most often incorrect based on subscribers' first attempt of all problems (study and exam mode)
Problem(s) most often incorrect based on subscribers' first attempt of all problems (exam mode only)
Problem(s) most often incorrect based on all subscribers' attempts of all problems (study and exam mode)
Problem(s) most often incorrect based on all subscribers' attempts of all problems (exam mode only)
Problem(s) most often correct based on subscribers' first attempt of all problems (study and exam mode)
Problem(s) most often correct based on subscribers' first attempt of all problems (exam mode only)
Problem(s) most often correct based on all subscribers' attempts of all problems (study and exam mode)
Problem(s) most often correct based on all subscribers' attempts of all problems (exam mode only)
For those subscribers reporting a FAIL—what is the average number of problem views?
For those subscribers reporting a FAIL—what is the average time spent working problems?
For those subscribers reporting a PASS—what is the average number of problem views?
For those subscribers reporting a PASS—what is average time spent working problems?
For those subscribers reporting a FAIL—which problem is most often incorrect based on their first attempt of all problems (study and exam mode)
For those subscribers reporting a FAIL—which problem is most often incorrect based on their first attempt of all problems (exam mode only)
For those subscribers reporting a FAIL—which problem is most often incorrect based on all attempts of all problems (study and exam mode)
For those subscribers reporting a FAIL—which problem is most often incorrect based on all attempts of all problems (exam mode only)
For those subscribers reporting a PASS—which problem is most often incorrect based on their first attempt of all problems (study and exam mode)
For those subscribers reporting a PASS—which problem is most often incorrect based on their first attempt of all problems (exam mode only)
For those subscribers reporting a PASS—which problem is most often incorrect based on all attempts of all problems (study and exam mode)
For those subscribers reporting a PASS—which problem is most often incorrect based on all attempts of all problems (exam mode only)

The Analytics Module of the present invention further provides detailed information concerning whether further work may be required by the user to prepare for an upcoming examination. For example, depending on the number of questions missed, the types of questions missed, and other like information concerning the questions missed on the study guides and/or mock examinations, the Analytics Module of the present invention may determine whether the user suffers minor deficiencies or major deficiencies in their preparation. Specifically, the present invention may inform the user, based on one or more data points tracked whether the user is likely or not to pass the upcoming examination. Therefore, the present invention may enable a user to save time and money in moving forward with attempting the examination until the user is ready for the examination. This information may be provided to the user upon completion of a study guide or mock examination, or as apparent to one of ordinary skill in the art.

The analytics module may include other analytics functions, such as incorporating printer-friendly reports or making reports available online to various users of the present invention. Moreover, other analytics functions may be incorporated, such as video analytics, Google analytics or other like analytics. Moreover, user notes may also be made accessible to users for review at the end of sessions.

The analytics may be utilized to score examinations, such as mock examinations or real examinations. If a user successfully completes a course lecture series or examination, the analytics module may present to the user a formatted certificate.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system for delivering educational content to a user comprising:
a computer system comprising a first module for allowing a first user to upload instructions relating to educational material for presentation to a second user, a second module for allowing access to the educational material by the second user, a third module for allowing an advertiser to upload advertisement content for presentation to the first user and/or the second user, and a fourth module providing analytical information relating to the second user or the advertisement, wherein the advertisement is targeted to the instructor and/or the user based on the subject matter of the educational material.

2. The system of claim 1 wherein the educational material is selected from the group consisting of a lecture series, a study guide, an examination and combinations thereof.

3. The system of claim 1 wherein the instructions include entering information concerning the educational material, wherein the information is selected from the group consisting of text, video, photographs, graphics, sound, and combinations thereof.

4. The system of claim 1 wherein the educational information is entered in the form of a stem.

5. The system of claim 4 wherein the stem is in the form of a lecture, a study guide, and a question.

6. The system of claim 4 wherein the stem is in the form of at least one question, wherein the questions are selected from the group consisting of a true or false question, a multiple choice question, and an essay reveal question.

7. The system of claim 1 wherein the advertisement content is presented to the second user in a presentation associated with the educational material.

8. The system of claim 1 wherein the advertisement content is presented to the first user based on the educational material.

9. The system of claim 1 wherein the second user may select the advertisement content presented to the second user, and further wherein the system records the selection of the advertisement content by the second user.

10. The system of claim 1 wherein analytics module tracks the presentation of the educational material to the second user.

11. A method for delivering educational content to a user comprising:
Providing a computer system comprising a first module for allowing a first user to upload instructions relating to educational material for presentation to a second user, a second module for allowing access to the educational material by the second user, a third module for allowing an advertiser to upload advertisement content for presentation to the first user and/or the second user, and a fourth module providing analytical information relating to the second user or the advertisement,
uploading the instructions relating to the education material by the first user into the first module;
accessing the educational material by the second user using the second module;
uploading advertisement content into the third module by the advertiser;
presenting the advertisement content to the second user; and
targeting the advertisement to the second user based on the subject matter of the educational material.

12. The method of claim 11 wherein the educational material is selected from the group consisting of a lecture series, a study guide, an examination and combinations thereof.

13. The method of claim 11 wherein the instructions include entering information concerning the educational material, wherein the information is selected from the group consisting of text, video, photographs, graphics, sound, and combinations thereof.

14. The method of claim 11 wherein the educational information is entered in the form of a stem.

15. The method of claim 14 wherein the stem is in the form of a lecture, a study guide, and a question.

16. The method of claim 14 wherein the stem is in the form of at least one question, wherein the questions are selected from the group consisting of a true or false question, a multiple choice question, and an essay reveal question.

17. The method of claim 11 wherein the advertisement content is presented to the second user in a presentation associated with the educational material.

18. The method of claim 11 further comprising the step of:
presenting the advertising content to the first user based on the subject matter of the educational material.

19. The method of claim 11 further comprising the steps of:
selecting the advertisement content by the second user, and
recording the selection of the advertisement content by the second user.

20. The method of claim 11 further comprising:
tracking the presentation of the educational material to the second user by the analytics module.
